(19) United States
(12) Patent Application Publication
(10) Pub. No.: US 2019/0189384 A1
(43) Pub. Date: Jun. 20, 2019

(54) BIPOLAR GRID FOR CONTROLLING AN ELECTRON BEAM IN AN X-RAY TUBE

(71) Applicant: VAREX IMAGING CORPORATION, Salt Lake City, UT (US)

(72) Inventors: Colton B. Woodman, West Valley City, UT (US); Christopher M. Lewis, Kaysville, UT (US)

(21) Appl. No.: 15/845,046

(22) Filed: Dec. 18, 2017

(51) Int. Cl. H01J 35/04; H01J 35/06; H05G 1/30; H01J 35/10; H05G 1/02

(52) U.S. Cl. CPC H01J 35/045; H01J 35/06; H01J 2201/304; H01J 35/101; H05G 1/02; H05G 1/30

(57) ABSTRACT

A bipolar grid may be positioned between a cathode and an anode. The bipolar grid may receive a positive grid voltage that corresponds to a voltage in an electric field between the cathode and the anode such that the grid does not interfere with an electron beam generated by an electron emitter of the cathode. The bipolar grid may receive a negative grid voltage to isolate the electron emitter such that the electron beam does not reach the anode.

### BACKGROUND

The present disclosure generally relates to X-ray tubes, including embodiments relating to controlling electron beams generated in X-ray tubes.

X-ray tubes are used in a variety of industrial and medical applications. For example, X-ray tubes are employed in medical diagnostic examination, therapeutic radiology, semiconductor fabrication, and material analysis. More specifically, X-ray tubes are often used in computed tomography (CT) or X-ray imaging systems to analyze patients in medical imaging procedures or objects during package scanning.

During operation of a typical X-ray tube, an electrical current may be supplied to an electron emitter or filament of a cathode. This causes electrons to be formed on the emitter via a process known as thermionic emission. The electrons accelerate from the emitter toward a target track formed on the anode in the presence of a high voltage differential applied between the anode and the cathode. Upon striking the anode, some of the resulting kinetic energy from the striking electrons is converted into X-rays. The region of the anode upon which the majority of the electrons collide is generally referred to as a “focal spot.” The resulting X-rays may then pass through an X-ray transmissive window and are directed towards patient or other object to be examined. In a typical environment, an image is provided based on the X-rays that pass through the patient/object.

The claimed subject matter is not limited to embodiments that solve any disadvantages or that operate only in environments such as those described above. This background is only provided to illustrate examples of where the present disclosure may be utilized.

### BRIEF DESCRIPTION OF THE DRAWINGS

FIG. 1A is a perspective view of an example X-ray tube in which one or more embodiments described herein may be implemented.

FIG. 1B is a side view of the X-ray tube of FIG. 1A.

FIG. 1C is a cross-sectional view of the X-ray tube of FIG. 1A.

FIG. 2A is a top perspective view of an example of a cathode assembly.

FIG. 2B is a bottom perspective view of the cathode assembly of FIG. 2A.

FIG. 2C is a perspective view of a portion of the cathode assembly of FIG. 2A.

FIG. 2D is a perspective view of another portion of the cathode assembly of FIG. 2A.

FIGS. 3A-3C are schematic representations of electron beams.

FIG. 4 is an example emission chart illustrating the relationship between emitter temperature, grid voltage, and beam current.

### DETAILED DESCRIPTION

Reference will be made to the drawings and specific language will be used to describe various aspects of the disclosure. Using the drawings and description in this manner should not be construed as limiting its scope. Additional aspects may be apparent in light of the disclosure, including the claims, or may be learned by practice.

In an X-ray tube, electrons are typically generated using an electron emitter. In the presence of a voltage differential, the electrons may then be directed to a focal spot or a target on an anode, and upon striking the target, some of the resulting energy generated from the electron collision with the anode is converted into X-rays. The X-rays generated by the X-ray tube may then be directed to a patient or an object for analysis or treatment.

In some circumstances, it may be desirable to control the amount of X-rays provided to a patient or an object. This may be accomplished by turning the X-ray tube on and off over a specific time period. However, there may be some delay between the time the X-ray tube is turned on and X-rays are produced, and between the time the X-ray tube is turned off and X-rays cease. Accordingly, precisely controlling the dosage of X-rays provided to a patient or an object may depend on how quickly an X-ray tube responds to being turned on and off In particular, if an X-ray tube quickly starts and stops producing X-rays, the X-ray dosage provided to a patient or an object may be more accurately controlled.

Typically, the electron beam from an X-ray tube is turned on and off by changing the electrical current through the electron emitter. For example, an electrical current may be provided through the electron emitter to turn the electron beam on, and the electrical current may be turned off to turn the electron beam off. However, in such configurations, the response speed of the X-ray tube depends on thermal characteristics of the electron emitter. In particular, the electron emitter needs to heat up above a specific temperature threshold to emit electrons, typically referred to as thermionic emission. Thus, there is a delay between the time electrical current is provided through the electron emitter and the time the electron beam is emitted, because of the time it takes for the electron emitter to be heated above the temperature threshold. Similarly, the electron emitter needs to cool down below the temperature threshold to cease emitting electrons. Accordingly, there may be a delay between the time electrical current is turned off and the time the electron beam is emitted, because of the time it takes for the electron emitter to cool down below the temperature threshold.

The delay for the electron emitter to heat up and cool down depends on the thermal time constant of the electron emitter, which in turn depends on various characteristics such as the material, shape, and/or surface area of the electron emitter.

One type of emitter used in X-ray tubes is a coil filament. A coil filament is typically formed of a wire arranged in a spiral or helical configuration. Advantages of coil filaments include lower cost and widespread use in X-ray tubes. Another type of emitter that may be used in X-ray tubes is a flat or planar emitter. X-ray tube configurations with flat or planar emitters may be more expensive, but they generally have better X-ray emission characteristics. In particular, planar emitters typically have larger emission surface areas, and therefore are capable of generating more electrons and a more uniform electron density distribution in the electron beam. In addition, planar emitters may create better focal spots, which may improve imaging characteristics. Other types of emitters that may be implemented include bulk emitters, dispenser cathodes, indirectly heated or bombarded emitters, or field emission sources (such as nanotubes or carbon nanotubes).

Some X-ray tubes may include a grid configured to receive a grid voltage to control the electron beam emitted by the electron emitter. The grid may be used to focus and/or steer electrons emitted by the electron emitter. Additionally or alternatively, the grid may be used to “cut off” the electron beam by providing a sufficiently large voltage difference to prevent the electron beam from reaching the target and/or the focal spot. In particular, the grid voltage may stop the electrons from flowing by isolating the electron emitter from the high voltage field that the electron beam travels through. Thus, the grid may be used to reduce the electron beam current by limiting the number of electrons that are able to reach the anode. In some circumstances, grid cutoff may be used to turn the electron beam on and off rather than turning the electron emitter on and off, which may have a longer delay because of the thermal characteristics of the emitter. Accordingly, “cutting off” the electron beam may be used for controlling the amount of total X-rays received by a patient or object during an X-ray scan.

Typically, a grid needs to be positioned relative to the emitter in a manner to provide suitable electron beam cutoff without interfering with the electron beam when the X-ray tube is operating. Because of the shape and size of coil filaments, and the slots in the cathode that receive coil filaments, the grid may be positioned relatively close to a coil filament without interfering with the electron beam, and in such configurations the grid voltage necessary to cut off the electron beam may be relatively low. In contrast, the surface area of flat or planar emitters is generally larger, and the openings in the cathode that receive such emitters are also generally larger. Accordingly, the grid would generally need to be positioned further from the flat or planar emitter to avoid interfering with the electron beam during operation, and would therefore require a much higher grid voltage to cut off the electron beam. However, in some circumstances, it may not be practicable to increase the grid voltage because of limitations on the power supply (e.g., a generator) or the electrical couplings that transmit the voltage to the X-ray tube (e.g., electrical couplings extending into a vacuum envelope of the X-ray tube).

The disclosed embodiments may facilitate using a grid positioned between the cathode and the anode to provide electron beam cutoff. In some aspects, the grid may provide suitable electron beam cutoff without influencing the electron beam when the X-ray tube is operating. In addition, the described aspects may be implemented for cathodes with any suitable emitter types, including coil filaments, flat or planar emitters, bulk emitters, indirectly heated emitters, bombarded emitters, field emission emitters, or others. Accordingly, aspects of the disclosure address the challenges in providing a grid for electron beam cutoff for flat or planar emitter cathodes or other high electron density emission sources (e.g. dispenser cathodes). For example, the disclosed embodiments may be implemented in flat or planar emitter cathodes without requiring relatively high grid voltages to cut off the electron beam.

Aspects of the disclosure include a bipolar grid positioned in front of a cathode head to provide beam cutoff In some circumstances, a grid positioned in front of a cathode head may cause undesired focusing effects or the grid may otherwise interfere with the electron beam. However, in the disclosed embodiments the grid may be bipolar such that the voltage of the grid may be either positive or negative with respect to the voltage of the cathode. In such configurations, the grid may be subject to a positive voltage while the X-ray tube is operating to generate an electron beam. The positive voltage of the grid may correspond with the voltage in the electric field between the cathode and the anode such that the grid voltage matches the typical X-ray tube voltage and therefore does not interfere with the electron beam. The voltage of the grid may be changed to a negative voltage to cutoff the electron beam by isolating the electron emitter from the electric field between the cathode and the anode.

Such configurations permit the grid to be positioned proximate the electron emitter on the cathode without interfering with the electron beam. In effect, the grid may be “hidden” in the electric field because the voltage of the grid matches the voltage of the electric field. As the electrons pass proximate the grid, they are not disrupted by the grid and continue to travel to the anode uninterrupted. In addition, the grid may be positioned relatively close to the electron emitter without interfering with the electron beam, therefore a relatively high grid voltage is not required to cut off the electron beam.

The disclosed embodiments may permit the electron beam from the X-ray tube to be turned on and off more quickly than X-ray tubes that are controlled by changing the electrical current through the electron emitter. Such configurations may permit more accurate control of X-ray dosage provided to a patient or an object. Specifically, the disclosed embodiments avoid the delay in turning the electron emitter on and off caused when the electron emitter warms up and cools down.

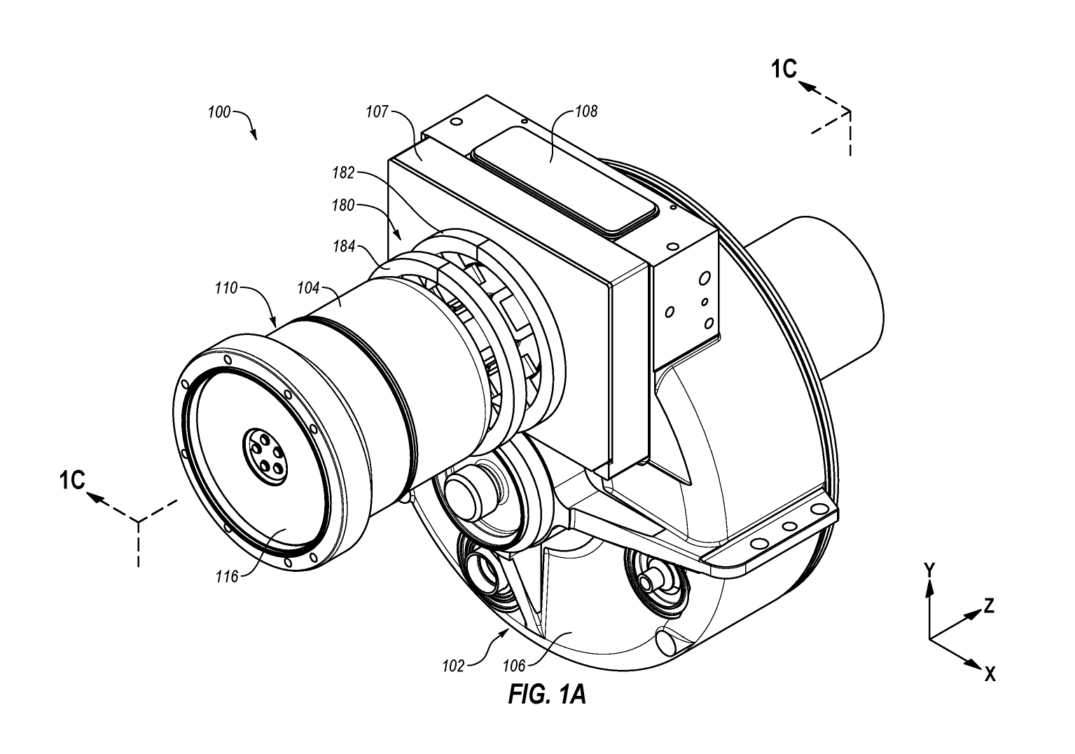

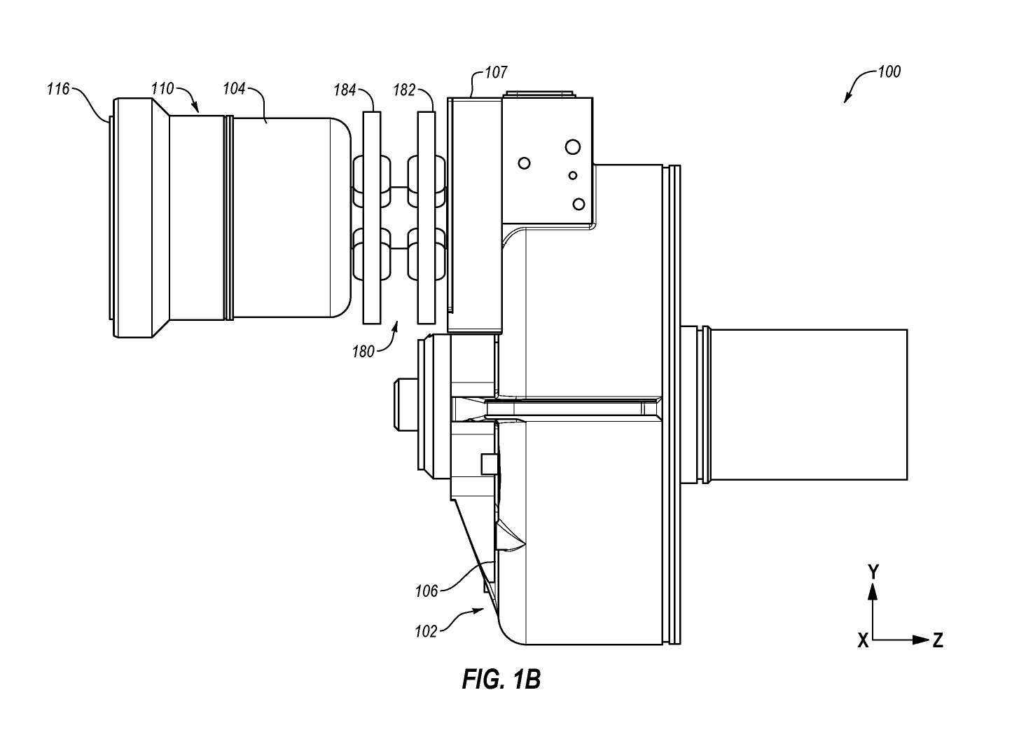

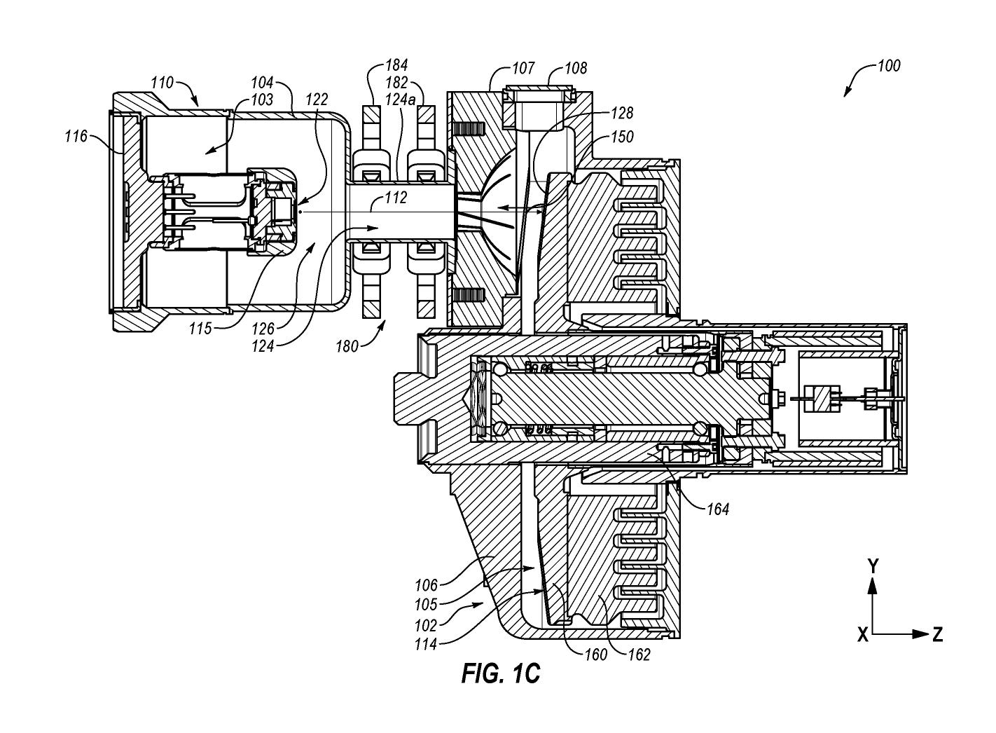

FIGS. 1A-1C are views of one example of an X-ray tube 100 in which one or more embodiments described herein may be implemented. Specifically, FIG. 1A is a perspective view of the X-ray tube 100 and FIG. 1B is a side view of the X-ray tube 100, while FIG. 1C is a cross-sectional view of the X-ray tube 100. The X-ray tube 100 illustrated in FIGS. 1A-1C represents an example operating environment and is not meant to limit the embodiments described herein.

Generally, X-rays are generated within the X-ray tube 100, some of which then exit the X-ray tube 100 to be utilized in one or more applications. The X-ray tube 100 may include a vacuum enclosure structure 102 which may act as the outer structure of the X-ray tube 100. The vacuum enclosure structure 102 may include a cathode housing 104 and an anode housing 106. The cathode housing 104 may be secured to the anode housing 106 such that an interior cathode volume 103 is defined by the cathode housing 104, and an interior anode volume 105 is defined by the anode housing 106, each of which are joined so as to define the vacuum enclosure 102.

In some embodiments, the vacuum enclosure structure 102 is disposed within an outer housing (not shown) within which a coolant, such as liquid or air, is circulated so as to dissipate heat from the external surfaces of the vacuum enclosure 102. An external heat exchanger (not shown) is operatively connected so as to remove heat from the coolant and recirculate it within the outer housing.

The X-ray tube 100 of FIGS. 1A-1C includes a shield component 107 (e.g., sometimes referred to as an electron shield, aperture, or electron collector) that is positioned between the anode housing 106 and the cathode housing 104 so as to further define the vacuum enclosure 102. The cathode housing 104 and the anode housing 106 may each be welded, brazed, or otherwise mechanically coupled to the shield 107.

The X-ray tube 100 may also include an X-ray transmissive window 108. Some of the X-rays that are generated in the X-ray tube 100 may exit through the window 108. The window 108 may be composed of beryllium or another suitable X-ray transmissive material.

With specific reference to FIG. 1C, the cathode housing 104 forms a portion of the X-ray tube referred to as a cathode assembly 110. The cathode assembly 110 generally includes components that relate to the generation of electrons that together form an electron beam, denoted at 112. The cathode assembly 110 may also include the components of the X-ray tube between an end 116 of the cathode housing 104 and an anode 114. For example, the cathode assembly 110 may include a cathode head 115 having an electron emitter, generally denoted at 122, disposed at an end of the cathode head 115. As will be further described, in some embodiments the electron emitter 122 can be configured as a planar electron emitter. When an electrical current is applied to the electron emitter 122, the electron emitter 122 is configured to emit electrons via thermionic emission, that together form a laminar electron beam 112 that accelerates towards the anode target 128.

The cathode assembly 110 may additionally include an acceleration region 126 further defined by the cathode housing 104 and adjacent to the electron emitter 122. The electrons emitted by the electron emitter 122 form an electron beam 112 and traverse through the acceleration region 126 and accelerate towards the anode 114 due to a suitable voltage differential. More specifically, according to the arbitrarily-defined coordinate system included in FIGS. 1A-1C, the electron beam 112 may accelerate in a z-direction, away from the electron emitter 122 in a direction through the acceleration region 126.

The cathode assembly 110 may additionally include at least part of a drift region 124 defined by a neck portion 124a of the cathode housing 104. In this and other embodiments, the drift region 124 may also be in communication with an opening 150 provided by the shield 107, thereby allowing the electron beam 112 emitted by the electron emitter 122 to propagate through the acceleration region 126, the drift region 124 and opening 150 until striking the anode target surface 128. In the drift region 124, a rate of acceleration of the electron beam 112 may be reduced from the rate of acceleration in the acceleration region 126. As used herein, the term “drift” describes the propagation of the electrons in the form of the electron beam 112 through the drift region 124.

Positioned within the anode interior volume 105 defined by the anode housing 106 is the anode 114. The anode 114 is spaced apart from and opposite to the cathode assembly 110 at a terminal end of the drift region 124. Generally, the anode 114 may be at least partially composed of a thermally conductive material or substrate, denoted at 160. For example, the conductive material may include tungsten or molybdenum alloy. The backside of the anode substrate 160 may include additional thermally conductive material, such as a graphite backing, denoted at 162.

The anode 114 may be configured to rotate via a rotatably mounted shaft positioned in a bearing housing, denoted here as 164, which rotates via an inductively induced rotational force on a rotor assembly via ball bearings, liquid metal bearings or other suitable structure. As the electron beam 112 is emitted from the electron emitter 122, electrons impinge upon the target surface 128 of the anode 114. The target surface 128 is annular or ring-shaped and may be positioned around the rotating anode 114. The location in which the electron beam 112 impinges on the target surface 128 is known as a focal spot (not shown). The target surface 128 may be composed of tungsten or a similar material having a high atomic (“high Z”) number. A material with a high atomic number may be used for the target surface 128 so that the material will correspondingly include electrons in “high” electron shells that may interact with the impinging electrons to generate X-rays.

During operation of the X-ray tube 100, the anode 114 and the electron emitter 122 are connected in an electrical circuit. The electrical circuit allows the application of a high voltage potential between the anode 114 and the electron emitter 122. Additionally, the electron emitter 122 is connected to a power source such that an electrical current is passed through the electron emitter 122 to cause electrons to be generated by thermionic emission. The application of a high voltage differential between the anode 114 and the electron emitter 122 causes the emitted electrons to form an electron beam 112 that accelerates through the acceleration region 126 and the drift region 124 towards the target surface 128. Specifically, the high voltage differential causes the electron beam 112 to accelerate through the acceleration region 126 and then drift through the drift region 124. As the electrons within the electron beam 112 accelerate, the electron beam 112 gains kinetic energy. Upon striking the target surface 128, some of this kinetic energy is converted into electromagnetic radiation having a high frequency, i.e., X-rays. The target surface 128 is oriented with respect to the window 108 such that the X-rays are directed towards the window 108. At least some portion of the X-rays then exit the X-ray tube 100 via the window 108.

In some embodiments, the X-ray tube 100 may include one or more electron beam manipulation components. Such components can be implemented to “focus,” “steer” and/or “deflect” the electron beam 112 before it traverses the region 126, thereby manipulating or “toggling” the dimension and/or the position of the focal spot on the target surface 128. Additionally or alternatively, a manipulation component or system can be used to alter or “focus” the cross-sectional shape (e.g., length and/or width) of the electron beam and thereby change the shape and dimension of the focal spot on the target 128. In some configurations, the components configured to “focus,” “steer” and/or “deflect” the electron beam may be located on the cathode head 115 and/or the cathode assembly 110. In the illustrated embodiments electron beam focusing and steering are provided by way of a magnetic system denoted generally at 180.

The magnetic system 180 may include various combinations of focusing quadrupoles, steering quadrupoles, steering coils, and steering dipoles implementations that are disposed so as to impose magnetic forces on the electron beam 112 so as to focus and/or steer the beam. One example of the magnetic system 180 is shown in FIGS. 1A-1C. In this embodiment, the magnetic system 180 is implemented as two magnetic cores 182, 184 disposed in the electron beam path 112 of the X-ray tube 100. The combination of the two cores 182, 184 are configured to (a) focus in both directions perpendicular to the beam path, and (b) to steer the beam in both directions perpendicular to the beam path. In this way, the two cores 182, 184 can have quadrupoles that act together to form a magnetic lens (sometimes referred to as a “doublet”), and the focusing and steering is accomplished as the electron beam passes through the quadrupole “lens.” The “focusing” provides a desired focal spot shape and size. Additionally, the magnetic system 180 can be configured with at least one coil or a pair of coils that have an AC offset, and preferably two perpendicular pairs of coils that have an AC offset, used for steering. The steering can be implemented by configurations of the two or more cores 182 and 184. The “steering” affects the positioning of the focal spot on the anode target surface 128. The magnetic system 180 may be substituted with any of the other suitable focusing or steering configuration.

The embodiments described herein may be implemented with any suitable focusing or steering structures, such as a spatial, magnetic, electrostatic, or combination thereof. The described embodiments may be implemented using a single electrostatic focusing grid or multiple grid configurations (e.g., dual grids). In other configurations, embodiments may not include electrostatic focusing and may rely on other suitable focusing structures, such as spatial and/or magnetic.

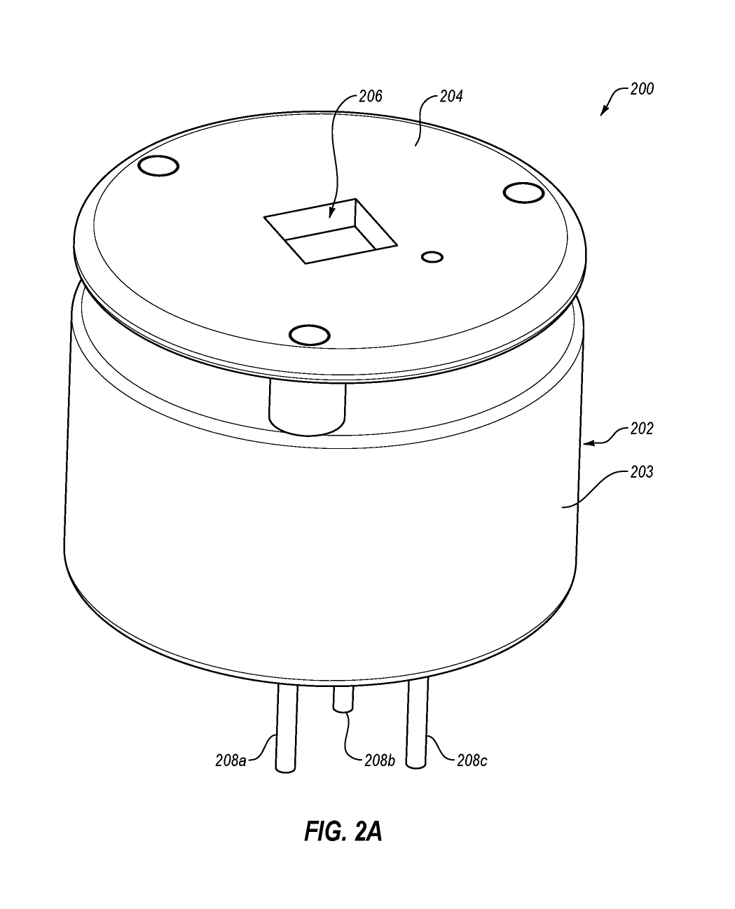

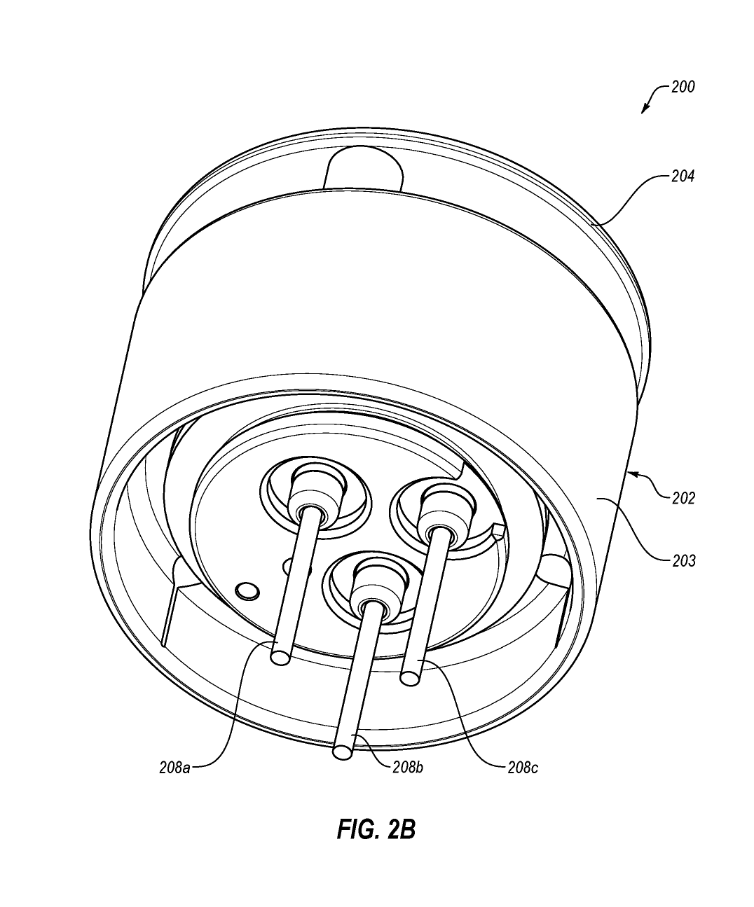

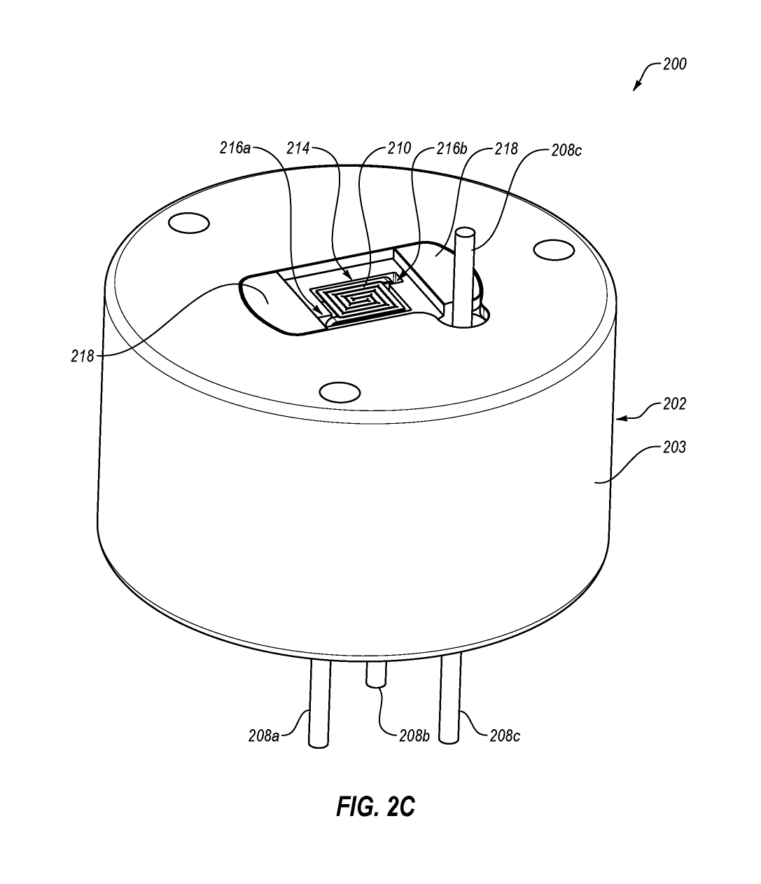

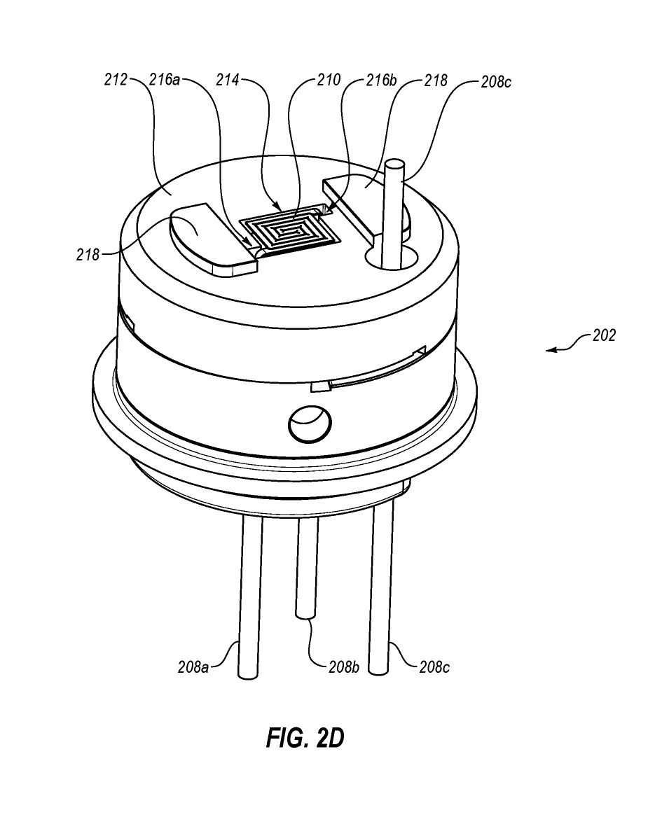

FIGS. 2A-2D are views of an example of a cathode assembly 200. In some configurations, the cathode assembly 200 may be implemented in the X-ray tube 100 of FIGS. 1A-1C, for example, instead of the cathode assembly 110. Any suitable aspects of the cathode assembly 200 may be included in the cathode assembly 110, or vice versa. Specifically, FIG. 2A is a top perspective view of the cathode assembly 200, FIG. 2B is a bottom perspective view of the cathode assembly 200, and FIGS. 2C-2D are perspective views of portions of the cathode assembly 200.

As illustrated for example in FIG. 2A-2B, the cathode assembly 200 may include a cathode head 202, a housing 203, and a grid 204. The grid 204 may be define an opening 206 sized and shaped to permit electrons generated by the cathode assembly 200 to travel therethrough. The grid 204 may be configured to control an electron beam generated at the cathode assembly 200. The cathode assembly 200 may include electrical couplings 208a, 208b, and 208c. A power source may be electrically coupled to the cathode assembly 200 via the electrical couplings 208a-c.

FIG. 2C is a perspective view of the cathode assembly 200 with the grid 204 not shown, and FIG. 2D is a perspective view of the cathode assembly 200 with the grid 204 and the housing 203 not shown. With attention to FIGS. 2C and 2D, additional aspects of the cathode assembly 200 will be described in further detail. In the illustrated configuration, the cathode assembly 200 includes a planar electron emitter 210 on an end of the cathode head 202. The electron emitter 210 may be oriented toward an anode, such the as the anode 114 of FIGS. 1A-1C, and may be configured to generate electrons or an electron beam directed to the anode 114. Although a planar electron emitter 210 is illustrated in this embodiment, any suitable emitter may be implemented. For example, in other configurations a spiral, helical, or coil filament may be implemented.

The electrical couplings 208a-c may extend at least partially through the cathode head 202 and be coupled to the electron emitter 210 and the grid 204. In particular, the electrical couplings 208a and 208b may be electrically coupled to the electron emitter 210 and the electrical coupling 208c may be electrically coupled to the grid 204. As shown, the electrical coupling 208c may extend entirely through the cathode head 202 to the grid 204.

The cathode head 202 may include a head surface 212 that has an emitter region 214. The emitter region 214 can have various configurations, for example, in the illustrated configuration the emitter region 214 is a recess defined in the cathode head 202. As shown, the recess may be sized and shaped to receive the electron emitter 210. In other configurations, the emitter region 214 may be a surface with an electron emitter positioned above or proximate the surface. The cathode head 202 may define lead openings 216a and 216b. The lead openings 216a, 216b may permit the electrical couplings 208a, 208b to extend through to cathode head 202 to the electron emitter 210. The electron emitter 210 includes an emitter body that extends continuously between the electrical coupling 208a and the 208b electrical coupling. The cathode head 202 may include electron beam focusing elements 218 positioned on the surface 212 on opposite sides of the electron emitter 210. The focusing elements 218 may be configured to focus an electron beam generated by the electron emitter 210.

In the illustrated configuration, the electron emitter 210 extends in a spiraling rectangular configuration, although any suitable pattern or configuration may be implemented. The pattern of the electron emitter 210 may be two-dimensional so as to form a planar emitter surface, where different regions of the electron emitter 210 cooperate to form the planar emitter surface. In the illustrated configuration, gaps (e.g., illustrated by lines between members) may be positioned between different regions of the electron emitter 210. The gaps may form a first continuous gap from a first end of the electron emitter 210 to a middle region of the electron emitter 210. The gaps may also form a second continuous gap from the middle region to a second end of the electron emitter 210. As shown, the electron emitter 210 is continuous and patterned so that electrical current flows from a first end of the electron emitter 210 to a second end. However, other arrangements, configurations, or patterns may be implemented.

In some configurations, the electron emitter 210 may include a tungsten foil, and alloy of tungsten, or other suitable material. The emitting surface of the electron emitter 210 may be coated with a composition that reduces the emission temperature. For example, the coating may include tungsten, tungsten alloys, thoriated tungsten, doped tungsten (e.g., potassium doped), zirconium carbide mixtures, barium mixtures or other coatings can be used to decrease the emission temperature.

As mentioned, the grid 204 may be configured to control an electron beam generated by the electron emitter 210. In particular, the grid 204 may be used to focus, direct, and/or cut off the electron beam from the electron emitter 210. The grid 204 may be electrically isolated from the cathode head 202 and may be configured to receive a grid voltage (e.g., via the electrical coupling 208c) to focus and/or steer electrons emitted by the electron emitter 210. Particularly, the grid 204 may focus the electron beam in one or more directions as the electron beam passes through the opening 206, and/or steer the electron beam in one or more directions. The voltage through the grid 204 may be modulated so as to provide an electron beam with a given dimension. Specifically, the voltage difference between the grid 204 and the electron emitter 210 may be modulated to change one or more cross-sectional dimension of the electron beam.

In some circumstances, the grid 204 may be used to cut off the electron beam by providing a sufficiently large voltage difference to prevent the electron beam from reaching the target and/or the focal spot. Cutting off the electron beam may be used for controlling the amount of total X-rays received by a patient or object during an X-ray scan. For example, cutting off the electron beam may be used to limit the amount of X-rays a patient or object receives during a scan. This may be useful, for example, during cardiac scanning of a patient. Accordingly, the grid 204 may be used to control the emission of X-rays from the X-ray tube by cutting off electron beams from the electron emitter 210.

The grid 204 may be a bipolar grid positioned in front of the cathode head 202 to provide beam cutoff for the electron beam generated by the electron emitter 210. In particular, the grid 204 may receive both a positive and a negative voltage. The grid 204 may be configured to have a positive voltage while the electron emitter 210 generates an electron beam. The positive voltage of the grid 204 may correspond with the voltage in the electric field between the cathode and the anode such that the grid voltage matches the electric field voltage and therefore does not interfere with the electron beam from the electron emitter 210. The voltage of the grid 204 may be changed to a negative voltage to cut off the electron beam from the electron emitter 210 by isolating the electron emitter 210 from the electric field between the cathode and the anode. Additionally or alternatively, the voltage of the grid 204 may be changed to a negative voltage to inhibit the flow of electrons and/or reduce electron density of the electron beam generated by the electron emitter.

Such configurations may permit the grid 204 to be positioned proximate the electron emitter 210 on the cathode head 202 without interfering with the electron beam. In effect, the grid 204 may be “hidden” in the electric field because the voltage of the grid 204 matches the voltage of the electric field. As the electrons pass proximate the grid 204, they are not disrupted by the grid 204 and continue to travel to the anode uninterrupted. In addition, the grid 204 may be positioned relatively close to the electron emitter 210 with interfering with the electron beam, therefore a relatively high grid voltage is not required to cut off the electron beam.

The illustrated configuration may permit the electron beam to be turned on and off more quickly than X-ray tubes that are controlled by changing the electrical current through the electron emitter 210. Such configurations may permit more accurate control of X-ray dosage provided to a patient or an object. Specifically, such configurations avoid the delay in turning the electron emitter 210 on and off caused when the electron emitter 210 warms up and cools down. In some circumstances, the delay to turn the electron beam 210 on and off may be reduced to be in the range of tens of microseconds. The grid 204 may provide suitable electron beam cutoff without influencing the electron beam when the X-ray tube is operating. The grid 204 may be implemented for cathodes with any suitable emitter types, including coil filaments and flat or planar emitters.

In some configurations, a power supply may be configured to swing the voltage of the grid 204 between a negative voltage and a positive voltage. In one example, a power supply may be configured to swing the voltage of the grid 204 between −4 kilovolts (kV) and +4 kV. In another example, a power supply may be configured to swing the voltage of the grid 204 between −10 kilovolts (kV) and +10 kV, although other configurations maybe implemented. In some circumstances, the voltage of the grid 204 may swing from a negative voltage and a positive voltage, and vice versa, in less than 100 microseconds.

The grid 204 may be formed of a material suitable for withstanding the operating conditions inside of the X-ray tube. For example, the grid 204 may include a material that is structurally robust and tolerant of the relatively large temperature changes in an X-ray tube. Additionally or alternatively, the grid 204 may include an electrically conductive material suitable for receiving the grid voltage from the power supply. In some configurations, the grid 204 may include nickel, stainless steel, tungsten, a tungsten alloy, molybdenum, a molybdenum alloy, niobium and/or other suitable materials. In some configurations, the grid 204 may include a refractory metal, in other configurations, a non-refractory metal may be implemented.

A thickness of the grid 204 may be selected to be sufficiently narrow to avoid electric field lens effects, where the grid 204 acts as a lens and distorts the electron beam as it travels through the opening 206. Additionally or alternatively, the thickness of the grid 204 may be selected to be sufficiently wide to be structurally robust and/or to withstand heat effects (e.g., expansion caused by temperature changes in the X-ray tube). In some configurations, the thickness of the grid 204 may be between 0.1 millimeters (mm) and 3 mm, between 1 millimeters (mm) and 2 mm, or any other suitable configurations.

In some configurations, size and shape of the opening 206 may be selected to correspond to the electron emitter 210 and/or the electron beam formed by the electron emitter 210. For example, in the illustrated configuration the electron emitter 210 is a flat emitter with a rectangular or square configuration, and thus the opening 206 includes a rectangular or square configuration, although other suitable configurations may be implemented. Similarly, the dimensions of the opening 206 may correspond to the dimensions of the electron emitter 210 and/or the electron beam. In some configurations, the size, shape, and position of the opening 206 may be selected such that electrons from the electron emitter 210 do not impact the grid 204. Such configurations of the grid 204 may be referred to as a “non-intercepting grid.” In contrast, an “intercepting grid” disturbs the electron beam and intercepts electrons traveling therethrough. An example of an intercepting grid is a mesh placed between a cathode and an anode. The mesh may not include an opening, such as the opening 206.

The grid 204 may be spaced from the cathode head 202 or the electron emitter 210. The distance or spacing may be based on the magnitude of the electric field between the cathode head 202 and an anode. The distance or spacing may be selected to be close enough the electron emitter 210 such that the grid voltage required to cut off or otherwise control the electron beam is not too large. Further, the distance or spacing may be selected to such that electrons from the electron emitter 210 do not impact the grid 204. In one example, the grid 204 may be positioned 2 mm from the cathode head 202. In another example, the grid 204 may be positioned between 0.01 and 10 mm from the cathode head 202. In some configurations, the grid 204 may be spaced from the cathode head 202 by standoff member(s) that retain the grid 204 with respect to the cathode head 202 while electrically insulating the grid 204 from the cathode head 202.

Additionally or alternatively, the geometry and the spacing of the grid 204 and the opening 206 may be based on the desired beam characteristics of the electron beam formed by the electron emitter 210. For example, the configuration of the grid 204 and the opening 206 may be different converging electron beams, diverging electron beams, and/or laminar flow electron beams.

In one example configuration, the opening 206 may include one or more dimensions of 8 mm (e.g., length, width, or diameter), the electron emitter 210 may include one or more dimensions of 5 mm, and the grid 204 may be positioned 2 mm from the cathode head 202.

In the illustrated configuration, the size and shape of the grid 204 generally corresponds to the size and shape of the cathode head 202, however, other configurations may be implemented. The size and shape of the grid 204 may be selected to suitably control the electron beam without necessarily corresponding to the size and shape of the cathode head 202.

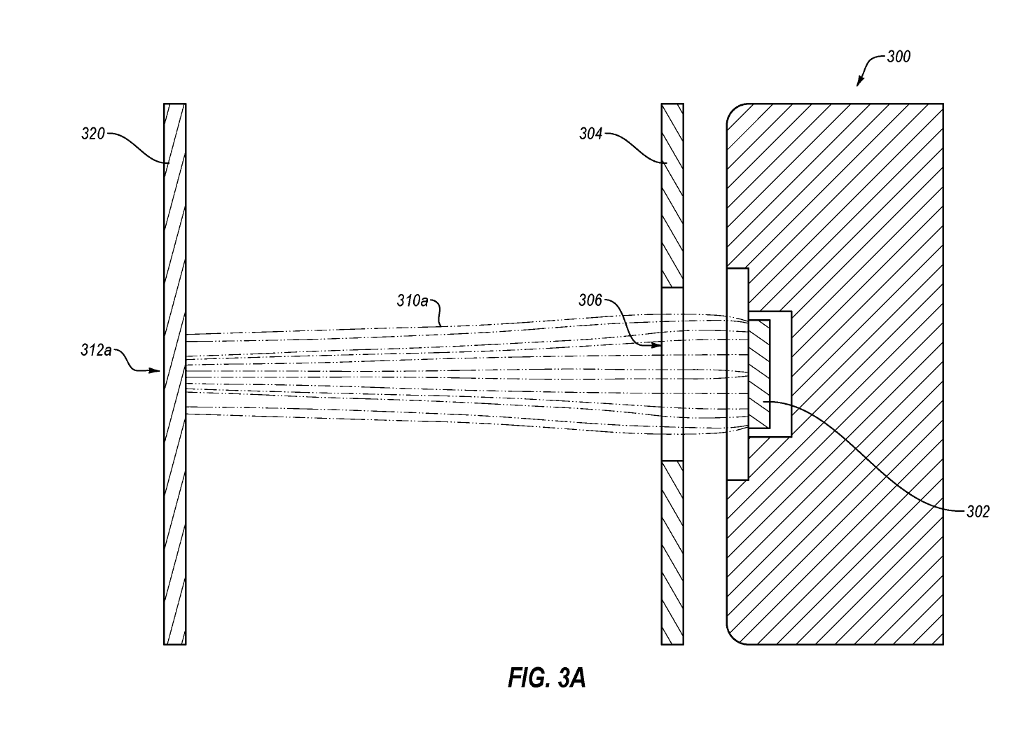

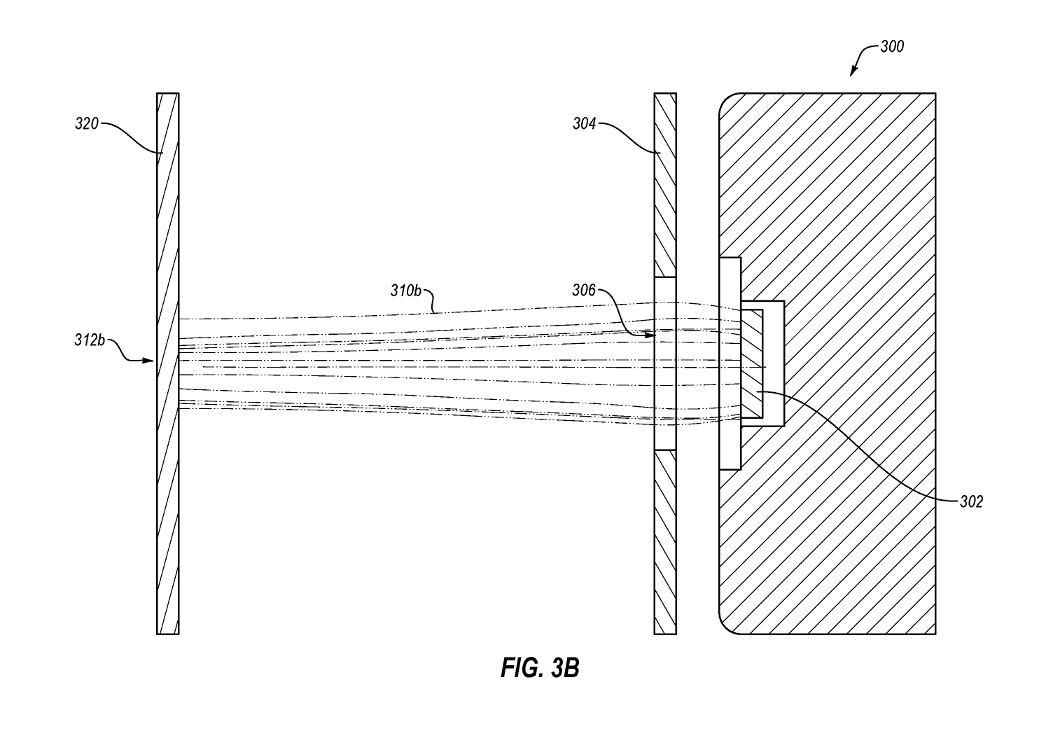

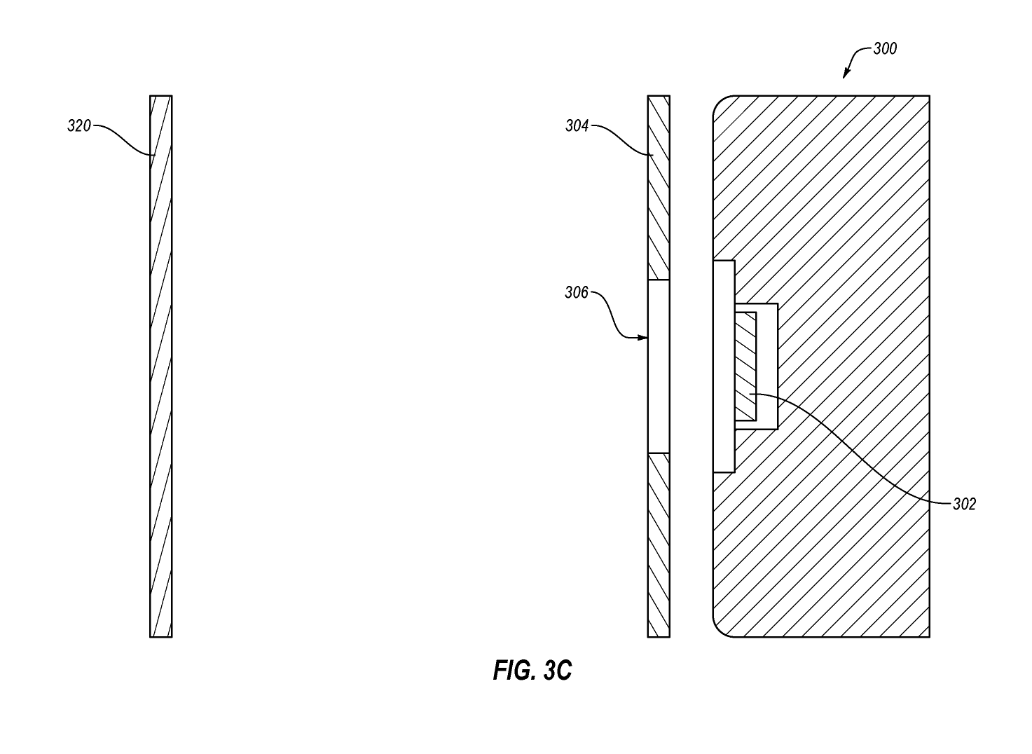

FIGS. 3A-3C are schematic representations of electron paths according to embodiments described herein. In particular, FIGS. 3A-3C include a cathode 300, an anode 320, and a grid 304 positioned therebetween. The cathode 300 includes an electron emitter 302 that is configured to generate electrons, or an electron beam. The grid 304 defines an opening 306 sized and shaped to permit electrons to travel between the emitter 302 and the anode 320. The cathode 300, anode 320, and grid 304 may include any suitable features described above.

In the configuration shown in FIG. 3A, the grid 304 is set to a positive potential relative to the cathode voltage. As shown, the grid 304 does not interrupt an electron beam 310a generated by the electron emitter 302. The electron beam 310a travels from the electron emitter 302, through the opening 306 defined in the grid 304, to a focal spot 312a on the anode 320. The voltage or potential of the grid 304 may be selected to correspond to or match the voltage of the electric field between the electron emitter 302 and the anode 320. In effect, the grid 304 may be “hidden” in the electric field in a manner not to disrupt the electron beam 310a.

In one example of the configuration of FIG. 3A, the tube voltage may be 80 kilovolts (kV), the grid voltage may be 4 kV relative to the cathode voltage, the temperature of the electron emitter 302 may be 2370 degrees Celsius (° C.), and the electron beam current may be 236 milliamps (mA).

FIG. 3B illustrates a configuration similar to FIG. 3A, except with a higher beam current and increased electron emitter temperature. In FIG. 3B, the grid 304 is also set to a positive potential relative to the cathode voltage and does not interrupt an electron beam 310b generated by the electron emitter 302. The electron beam 310b travels from the electron emitter 302, through the opening 306 defined in the grid 304, to a focal spot 312a on the anode 320. The voltage or potential of the grid 304 may be selected to correspond to or match the voltage of the electric field between the electron emitter 302 and the anode 320. In effect, the grid 304 may be “hidden” in the electric field in a manner not to disrupt the electron beam 310b.

In one example of the configuration of FIG. 3B, the tube voltage may be 80 kV, the grid voltage may be 4 kV relative to the cathode voltage, the temperature of the electron emitter 302 may be 2510° C., and the electron beam current may be 715 mA.

FIG. 3C illustrates a configuration similar to FIG. 3B, except the grid 304 is set to a negative potential to inhibit or cut off electron flow. As shown, the grid 304 cuts off the electron beam by providing a sufficiently large voltage difference to prevent the electron beam from reaching the anode 320. Accordingly, no electrons reach a focal spot on the anode 320.

In one example of the configuration of FIG. 3C, the tube voltage may be 80 kV, the grid voltage may be −4 kV (a negative voltage) relative to the cathode voltage, the temperature of the electron emitter 302 may be 2550° C., and the electron beam current may be 0 mA.

In such configurations, although electrons are not flowing from the electron emitter 302, the temperature of electron emitter 302 is still sufficiently high to generate electrons. Accordingly, the electron emitter 302 does not need to be heated up to be turned on or to generate electrons. Instead, the grid voltage must be changed from a negative voltage to a positive voltage to permit electrons to flow (for example, from −4 kV to +4 kV or from −10 kV to +10 kV). Thus, the delay to turn the electron beam on and off is much shorter, because it does not depend on the thermal characteristics of the electron emitter 302 (e.g., the time it takes for the electron emitter 302 to heat up and cool down). Rather, the delay to turn the electron beam on and off depends on how quickly the grid voltage may be changed from a suitable negative voltage to a positive voltage, or vice versa.

Although various example configurations for tube voltage, grid voltage, emitter temperature, and electron beam current are provided with respect to FIGS. 3A-3C, any suitable parameters may be implemented. For example, in other configurations the tube voltage of an X-ray tube may be 70 kV, 100 kV, 120 kV, 140 kV or any other suitable value. In another example, the tube voltage of an X-ray tube may be between 0 and 100 kV. Furthermore, in the illustrated configuration the grid voltage swings between −4 kV to +4 kV, however other suitable configurations may be implemented. In some circumstances, electron emitters with larger surface areas may require larger grid voltage swings to “hide” the grid and/or provide suitable electron beam cutoff. Accordingly, grids may be implemented with other suitable operational grid voltages and/or cutoff voltage. As used herein, an “operational grid voltage” may be grid voltage or range of voltages that is suitable for permitting electrons to travel from the electron emitter to the anode. A “cutoff voltage” may be grid voltage or range of voltages that is suitable for cutting off the electron beam. As explained above, the grids described herein may be configured to switch between the operational grid voltage and the cutoff voltage.

For some medical applications, the X-ray tube voltage may be between 60 kV and 150 kV. For other applications, the X-ray tube may include other suitable X-ray tube voltage configurations. For example, for some industrial applications the X-ray tube voltage may be between 200 kV and 500 kV, although other suitable configurations may be implemented depending on the application. Accordingly, in various configurations the X-ray tube voltage may range between 1 and 500 kV.

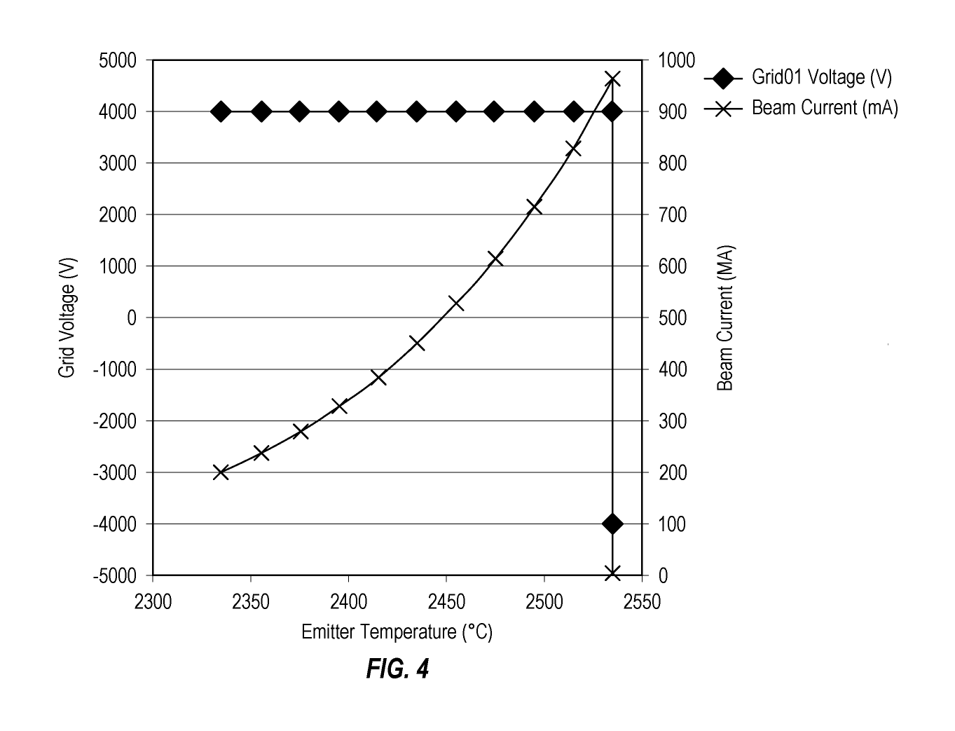

FIG. 4 is an example emission chart illustrating the relationship between emitter temperature, grid voltage, and beam current. FIG. 4 may be representative of the relationship between emitter temperature, grid voltage, and beam current for the configuration of FIGS. 3A-3C. In FIG. 4, beam current is expressed in mA, emitter temperature is expressed in ° C., and grid voltage is expressed in volts (V) with respect to the cathode voltage. As shown, the beam current increases as emitter temperature increases. The grid voltage does not affect beam current when the grid voltage is set to 4000 V. However, when the voltage is set to −4000 V, the beam current drops to 0 mA, indicating electron beam cutoff.

Accordingly, in the configurations described herein, the grid voltage may be swung between a positive and a negative voltage while maintaining a desired temperature in the electron emitter. This permits the electron beam to be cut off or otherwise controlled rapidly, without significant delays when the electron beam is turned on and off.

As mentioned, the delay for the electron emitter to heat up and cool down depends on the thermal time constant of the electron emitter, which in turn depends on various characteristics such as the material, shape, and/or surface area of the electron emitter. In some configurations, the delay for the electron emitter to heat up and/or cool down may be in the range of tens of milliseconds. The disclosed embodiments may permit the electron beam from the X-ray tube to be turned on and off more quickly than X-ray tubes that are controlled by changing the electrical current through the electron emitter (e.g., with a delay in the range of tens of milliseconds). Such configurations may permit more accurate control of X-ray dosage provided to a patient or an object. Specifically, the disclosed embodiments avoid the delay in turning the electron emitter on and off caused when the electron emitter warms up and cools down. In some circumstances, the delay to turn the electron beam on and off may be reduced to be in the range of tens of microseconds (e.g., a full order of magnitude faster).

Furthermore, in such configurations the voltage needed to shut off the electron beam may be lower than what would otherwise be required for ordinary, non-bipolar grids. For example, if the grid voltage swings between −4 kV and +4 kV, the total change in voltage is 8 kV. However, only a 4 kV maximum voltage needs to be supplied to the X-ray tube. If only a positive voltage is supplied to non-bipolar grid, the grid may require a voltage of 8 kV. However, it may be relatively difficult to manufacture X-ray tubes that handle larger voltages. In particular, various components of the X-ray tube, such as the electrically connections, may have to be more robust to handle larger voltages. Accordingly, the configurations described herein may include X-ray tubes with improved electron beam control and response, without requiring increased voltage handling and associated design complexity.

In some configurations, an X-ray tube (100) may include a cathode (110, 200, 300) including an electron emitter (122, 210, 302), an anode (114, 320) spaced apart from the cathode (110, 200, 300), a grid (204, 304) positioned between the cathode (110, 200, 300) and the anode (114, 320); and a power supply electrically coupled to the grid (204, 304). The power supply may be configured to provide a positive grid voltage and a negative grid voltage to the grid (204, 304).

The positive grid voltage may correspond to a voltage in the electric field between the cathode (110, 200, 300) and the anode (114, 320) such that the grid (204, 304) does not interfere with an electron beam generated by the electron emitter (122, 210, 302). The negative grid voltage may inhibit electron flow and/or reduce electron density of the electron beam generated by the electron emitter (122, 210, 302). The negative grid voltage may isolate the electron emitter (122, 210, 302) such that an electron beam does not reach the anode (114, 320). The negative grid voltage may be between 0 and −10 kilovolts (kV) and the positive grid voltage may be between 0 and 10 kV.

The grid (204, 304) may define an opening sized and shaped to permit electrons generated by the electron emitter (122, 210, 302) to pass therethrough. The grid (204, 304) may be electrically isolated from the cathode (110, 200, 300). The electron emitter (122, 210, 302) may include a planar emitter or a coil filament. The voltage of the X-ray tube (100) may be between 1 and 100 kilovolts (kV).

In some configurations, a bipolar grid (204, 304) may be positioned between a cathode (110, 200, 300) and an anode (114, 320). The bipolar grid (204, 304) may be configured to receive a positive grid voltage that corresponds to a voltage in an electric field between the cathode (110, 200, 300) and the anode (114, 320) such that the grid (204, 304) does not interfere with an electron beam generated by an electron emitter (122, 210, 302) of the cathode (110, 200, 300). The bipolar grid (204, 304) may be configured to receive a negative grid voltage to isolate the electron emitter (122, 210, 302) such that the electron beam does not reach the anode (114, 320).

The negative grid voltage may be between 0 and −10 kilovolts (kV) and the positive grid voltage may be between 0 and 10 kilovolts (kV). The bipolar grid (204, 304) may define an opening sized and shaped to permit electrons generated by the electron emitter (122, 210, 302) to pass therethrough. The size and shape of the opening may correspond to the electron emitter (122, 210, 302). The bipolar grid (204, 304) may be electrically isolated from the cathode (110, 200). The bipolar grid (204, 304) may be spaced apart from the cathode (110, 200, 300) between 0 and 10 mm.

In some configurations, a bipolar grid (204, 304) may be positioned between a cathode (110, 200, 300) and an anode (114, 320). The bipolar grid (204, 304) may be configured to swing between a positive grid voltage and a negative grid voltage. The positive grid voltage may correspond to a voltage in an electric field between a cathode (110, 200, 300) and an anode (114, 320) such that the bipolar grid (204, 304) does not interfere with an electron beam generated by an electron emitter (122, 210, 302) of the cathode (110, 200, 300).

The negative grid voltage may isolate the electron emitter (122, 210, 302) such that the electron beam does not reach the anode (114, 320). The negative grid voltage may be between 0 and −10 kilovolts (kV) and the positive grid voltage may be between 0 and 10 kV. The grid (204, 304) may define an opening sized and shaped to permit electrons generated by the electron emitter (122, 210, 302) to pass therethrough.

A method of operating the bipolar grid (204, 304) positioned between a cathode (110, 200, 300) and an anode (114, 320) may include providing a positive grid voltage to the bipolar grid (204, 304). The positive grid voltage may correspond to a voltage in an electric field between the cathode (110, 200, 300) and the anode (114, 320) such that the bipolar grid (204, 304) does not interfere with an electron beam generated by an electron emitter (122, 210, 302) of the cathode (110, 200, 300). The method may include swinging the bipolar grid (204, 304) to a negative grid voltage, wherein the negative grid voltage reduces electron density of the electron beam generated by the electron emitter (122, 210, 302). The negative grid voltage may isolate the electron emitter (122, 210, 302) such that the electron beam does not reach the anode (114, 320). The negative grid voltage may be between 0 and −10 kilovolts (kV) and the positive grid voltage is between 0 and 10 kV. The bipolar grid may define an opening sized and shaped to permit electrons generated by the electron emitter (122, 210, 302) to pass therethrough.

The terms and words used in this description and claims are not limited to the bibliographical meanings, but, are merely used to enable a clear and consistent understanding of the disclosure. It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those skilled in the art, may occur in amounts that do not preclude the effect the characteristic was intended to provide.

Aspects of the present disclosure may be embodied in other forms without departing from its spirit or essential characteristics. The described aspects are to be considered in all respects illustrative and not restrictive. The claimed subject matter is indicated by the appended claims rather than by the foregoing description. All changes which come within the meaning and range of equivalency of the claims are to be embraced within their scope.

What is claimed is:

1. An X-ray tube comprising:
a cathode including an electron emitter;
an anode spaced apart from the cathode;
a grid positioned between the cathode and the anode; and
a power supply electrically coupled to the grid, wherein the power supply is configured to provide a positive grid voltage and a negative grid voltage to the grid.

2. The X-ray tube of claim 1, wherein the positive grid voltage corresponds to a voltage in the electric field between the cathode and the anode such that the grid does not interfere with an electron beam generated by the electron emitter.

3. The X-ray tube of claim 1, wherein the negative grid voltage reduces electron density of an electron beam generated by the electron emitter.

4. The X-ray tube of claim 1, wherein the negative grid voltage isolates the electron emitter such that an electron beam does not reach the anode.

5. The X-ray tube of claim 1, wherein the negative grid voltage is between 0 and −10 kilovolts (kV) and the positive grid voltage is between 0 and 10 kV.

6. The X-ray tube of claim 1, wherein the grid defines an opening sized and shaped to permit electrons generated by the electron emitter to pass therethrough.

7. The X-ray tube of claim 1, wherein the electron emitter comprises a planar emitter or a coil filament.

8. The X-ray tube of claim 1, wherein the grid is electrically isolated from the cathode.

9. The X-ray tube of claim 1, wherein the voltage of the X-ray tube is between 1 and 500 kilovolts (kV).

10. A bipolar grid positioned between a cathode and an anode, the bipolar grid configured to:
receive a positive grid voltage that corresponds to a voltage in an electric field between the cathode and the anode such that the bipolar grid does not interfere with an electron beam generated by an electron emitter of the cathode; and
receive a negative grid voltage to isolate the electron emitter such that the electron beam does not reach the anode.

11. The bipolar grid of claim 10, wherein the negative grid voltage is between 0 and −10 kilovolts (kV).

12. The bipolar grid of claim 10, wherein the positive grid voltage is between 0 and 10 kilovolts (kV).

13. The bipolar grid of claim 10, wherein the bipolar grid defines an opening sized and shaped to permit electrons generated by the electron emitter to pass therethrough.

14. The bipolar grid of claim 10, wherein the bipolar grid defines an opening and the size and shape of the opening corresponds to the electron emitter.

15. The bipolar grid of claim 10, wherein the bipolar grid is electrically isolated from the cathode.

16. The bipolar grid of claim 10, wherein the bipolar grid is spaced apart between 0 and 10 mm from the cathode.

17. A method of operating a bipolar grid positioned between a cathode and an anode, the method comprising:
providing a positive grid voltage to the bipolar grid, wherein the positive grid voltage corresponds to a voltage in an electric field between the cathode and the anode such that the bipolar grid does not interfere with an electron beam generated by an electron emitter of the cathode; and
applying a negative grid voltage to the bipolar grid, wherein the negative grid voltage reduces electron density of the electron beam generated by the electron emitter.

18. The method of claim 17, wherein the negative grid voltage isolates the electron emitter such that the electron beam does not reach the anode.

19. The method of claim 17, wherein the negative grid voltage is between 0 and −10 kilovolts (kV) and the positive grid voltage is between 0 and 10 kV.

20. The method of claim 17, wherein the bipolar grid defines an opening sized and shaped to permit electrons generated by the electron emitter to pass therethrough.
